(19) United States
(12) Patent Application Publication
(10) Pub. No.: US 2025/0225448 A1
(43) Pub. Date: Jul. 10, 2025

(54) A Data-Driven Bunker Planner System

(71) Applicant: National University of Singapore, Singapore (SG)

(72) Inventors: Qinghe SUN, Singapore (SG); Cheng-Feng CHOU, Singapore (SG); Ying CHEN, Singapore (SG)

(21) Appl. No.: 18/853,830

(22) PCT Filed: Mar. 23, 2023
(86) PCT No.: PCT/SG2023/050193

§ 371 Date: Oct. 3, 2024

(30) Foreign Application Priority Data
Apr. 4, 2022 (SG) 10202203430W

(51) Int. Cl. G06Q 10/04; G06Q 30/0283

(52) U.S. Cl. CPC G06Q 10/04; G06Q 30/0283

(57) ABSTRACT

This invention describes a data-driven bunker planner system (11) for optimising refuel costs for a marine vessel (1). The bunker planner system (11) operates on a computing system (10) located on the vessel (1) and includes a data acquisition module (111), a fuel-price forecasting module (112) and a data optimisation module (113). The fuel-price forecasting module (112) forecasts the future fuel prices and/or fuel indexes in the long-term or the short-term. The data optimisation module (113) determines an optimal time to fulfil a refuel term contract or combinations of contracts based on the forecasted fuel prices and/or fuel indexes. The forecasted fuel prices and/or fuel indexes, the optimised fuel term contracts and a bunkering plan are outputted through a notification generation module (114) and a human-machine interface system (18). The bunker planner system outputs have been verified using real-life data trained on various customized machine learning and optimization models.

### RELATED APPLICATIONS

The present invention claims priority to Singapore patent application no. 10202203430W filed on 4 Apr. 2022, the disclosure of which is incorporated in its entirety.

### FIELD OF INVENTION

This invention relates to refuelling of a marine vessel. More particularly, the invention relates to a data-driven bunker planner system which optimises bunkering cost by forecasting fuel prices and optimising data related to a planned route, vessel fuel consumption, vessel fuel storage constraints and bunkering facility at a port of call.

### BACKGROUND OF THE INVENTION

Refuelling of a vessel refers to a process where the vessel is replenished with fuel for it to continue its intended function. Refuelling of a marine vessel is referred to as bunkering. Such vessels can only store finite amounts of fuel onboard, and hence, they would have to plan and to call at various ports during their journey for refuelling.

As not every port offers bunkering facility, the vessel's crew would need to plan for fuel procurement prior to or during the vessel's journey so that the vessel will have enough fuel to complete the journey. Preferably, to minimise operation costs of the vessel, the crew must take into account the price of fuel when performing refuelling at selected refuelling ports, or when entering refuelling contracts with a bunkering supplier.

However, the price of fuel may differ at each refuelling port. In addition to this, the price of fuel may fluctuate every day during the vessel's journey. As such, it may be difficult for a vessel's crew to optimally plan refuelling operations of the vessel. Depending on the price of fuel on a current day, it is preferable that an alternative route is considered, or that a refuelling contract is nominated for fulfilment, so as to optimise the costs of refuelling operations of the vessel.

There are a number of known systems that may relate to manage bunkering costs of a vessel. For example, U.S. Pat. No. 10,139,235, assigned to Nippon Yusen, describes a data processing device that generates display instruction data for a specified fuel oil price along with determination rules for a refuelling amount at one or more refuelling locations, and outputs data to a terminal device that displays information to be used for formulating a bunkering plan. The data process includes route identification, reference fuel oil price data, fuel oil price data, price determination rule, refuelling plan data, refuelling location, remaining oil data, refuel amount, per-route formulation rule and per-port formulation rule. With this data processing device, complex tasks in formulating a ship bunkering plan are simplified.

Another known technology is US publication No. 20160265920, assigned to Nippon Yusen, provides a refuelling plan that reduces fuel costs in a voyage of a ship. It also provides a device including acquisition units for fuel consumption, port-to-port distance, voyage plan, remaining fuel, fuel price, refuelling plan, fuel cost calculation and output notification relating to fuel cost to provide a bunkering plan.

However, it should be noted that U.S. Pat. No. 10,139,235 has no guarantee for the quality and performance of a pre-specified decision rule in terms of bunker cost optimisation. Whereas, US 20160265920 only generates one feasible refuel plan instead of the optimal refuel plan that minimizes expected future fuel costs. Accordingly, it would be desirable to have an invention that is data-driven to optimise refuel costs as a vessel moves from one port to another according to a scheduled route; preferably, some data relate to forecasting of fuel prices and/or fuel indexes and determining an optimal time, location and quantity to fulfil refuel contracts based on the forecasted fuel price or fuel index.

### SUMMARY OF INVENTION

The present invention seeks to provide a data-driven bunker planner system for optimising refuel costs for a marine vessel. To achieve this objective, the invention provides a computing system and a bunker planning system on the vessel. More specifically, the bunker planning system further includes a fuel price forecasting module and a data optimisation module. The forecasting module is to forecast the future fuel prices and/or fuel indexes in the long-term or the short-term. The data optimisation module is to determine an optimal route based on the forecasted fuel price and/or fuel index, as well as determine an optimal time to fulfil one or more refuel term contracts based on the forecasted fuel price and/or fuel index.

Advantageously, the present invention supports decision-making in a dynamic setting using a data-driven nonparametric approach. Moreover, the use of forecasting and data optimising allows a decision-maker to determine the most economical procurement quantity of fuel and make appropriate fuel procurement plans that incur the lowest costs. Not only that, the data-driven bunker planning system is compatibly implemented or integrated with vessel computing systems of the present day.

In one embodiment, the invention provides a data-driven bunker planning system for minimising refuel costs for a vessel. The data-driven bunker planning system forecasts fuel prices and/or fuel indexes and optimises data relating to a planned route, vessel fuel consumption, vessel constraints and port of call.

Preferably, the bunker planning system further determines an optimal time, quantity and location to refuel, to fulfil one or more refuel term contracts based on the forecasted fuel price and/or fuel index.

Preferably, the bunker planning system further comprises a data acquisition module.

Preferably, the data acquisition module further comprises a refuel term contract data acquisition sub-module, a feature data acquisition sub-module, a fuel data acquisition sub-module, a route data acquisition sub-module, a fuel consumption data acquisition sub-module, a vessel status data acquisition sub-module, and a port data acquisition sub-module.

Preferably, the bunker planning system further comprises a fuel price forecasting module.

Preferably, the fuel price forecasting module further comprises a long-term forecasting sub-module and a short-term forecasting sub-module.

Preferably, the bunker planning system further comprises a data optimisation module.

Preferably, the optimisation module further comprises a bunker plan optimisation sub-module and a nomination date optimisation sub-module.

Preferably, the bunker planning system further comprises a notification generation module.

Preferably, the notification generation module generates any one of a combination of notifications that include forecasted fuel prices and/or fuel indexes, refuel contract nominations, and an optimised bunkering plan.

Preferably, the fuel price forecasting module receives data from the feature data acquisition sub-module and the fuel price data acquisition sub-module.

Preferably, the fuel price forecasting module employs customized machine learning and optimization models for long-term forecasting and short-term forecasting selected from: Ensemble Lasso, Random Forest, XGBoost, Support Vector Machine, a trained Structural Prescriptive—Empirical Risk Management (SP-ERM) and a trained Truncated Scenario-wise Linear Decision Rule—Empirical Risk Management (TSLDR-ERM).

Preferably, the data optimisation module receives data from the data acquisition module and the fuel price forecasting module.

Preferably, the bunker planning system communicates with a server to feed information to the data acquisition module.

Preferably, the bunker planning system further comprises a human-machine interface system to allow a decision-maker to input information and for the bunker planning system to output an optimised bunkering plan.

In another embodiment, a method for minimising refuel costs for a vessel is provided, the method comprises forecasting fuel prices and/or fuel indexes using a data-driven bunker planning system on the vessel. Preferably, the method further comprises determining an optimal time, quantity and location to refuel, to fulfil one or more refuel term contracts based on short-term, long-term or a combination of short-term and long-term forecasted fuel prices and/or fuel indexes. Preferably, the step of forecasting fuel prices and/or fuel indexes employs customized machine learning and optimization models for long-term forecasting and short-term forecasting selected from: Ensemble Lasso, Random Forest, XGBoost, Support Vector Machine, trained Structural Prescriptive—Empirical Risk Management (SP-ERM) and trained Truncated Scenario-wise Linear Decision Rule—Empirical Risk Management (TSLDR-ERM).

One skilled in the art will readily appreciate that the invention is well adapted to carry out the objectives and obtain the ends advantages mentioned, as well as those inherent therein. The embodiments described herein are not intended as limitations on the scope of the invention.

### BRIEF DESCRIPTION OF THE DRAWINGS

To facilitate an understanding of the invention, there is illustrated in the accompanying drawings the preferred embodiments from an inspection of which when considered in connection with the following description, the invention, its construction and operation and many of its advantages would be readily understood and appreciated.

FIG. 1 illustrates the overall infrastructure in which the system and method of the present invention is to be implemented thereon.

FIG. 2 illustrates a detailed block diagram of the bunker planning system within the computing system in its preferred embodiment.

FIG. 3 illustrates an example of information organized within a refuel term contract data acquisition sub-module, which is part of a data acquisition module of the bunker planning system.

FIG. 4 illustrates an example of information organized within a feature data acquisition sub-module, which is part of the data acquisition module.

FIG. 5 illustrates an example of information organized within a fuel price index data acquisition sub-module, which is part of the data acquisition module.

FIG. 6 illustrates an example of information organized within a route data acquisition sub-module, which is part of the data acquisition module.

FIG. 7 illustrates an example of information organized within a fuel consumption data acquisition sub-module, which is part of the data acquisition module.

FIG. 8 illustrates an example of information organized within a vessel status data acquisition sub-module, which is part of the data acquisition module.

FIG. 9 illustrates an example of information organized within a port data acquisition sub-module, which is part of the data acquisition module.

FIG. 10 is a flowchart illustrating a flow of steps performed by the bunker plan optimisation sub-module, which is part of an optimisation module of the bunker planning system.

FIG. 11 is a flowchart illustrating a flow of steps performed by the nomination date optimisation sub-module, which is part of the optimisation module.

FIG. 12 illustrates an example of a first output of the notification generation module, being the forecasted fuel prices and/or fuel indexes.

FIG. 13 illustrates an example of a second output of the notification generation module, being the refuel contract nomination date.

FIG. 14 illustrates an example of a third output of the notification generation module, being the bunkering plan.

### DETAILED DESCRIPTION OF THE INVENTION

The present invention relates to a data-driven bunker planner system for optimising refuel costs for a marine vessel. The invention may also be presented in a number of different embodiments with common elements. According to a concept of the invention, the data-driven bunker system is located on the vessel that allows forecasting of fuel prices and/or fuel indexes as the vessel travelled on a planned route and determining a bunkering plan, within data optimisation related to refuelling constraints, fuel consumption and bunkering facility at a port of call.

It should be noted that in the context of the present invention, the term “vessel” may refer to boats, container vessels, cargo ships, bulk carriers, or the like.

It should be noted that in the context of the present invention, the term “port” may refer to a sea port, harbour, or any place in which a sea-based vessel is to berth, for example, for loading and unloading of cargoes.

Moreover, it should be noted that ports that have fuel suppliers that offer refuelling services may be referred to as “refuelling ports” or “bunkering ports”.

Moreover, it should be noted that ports that are planned stopping points for a vessel throughout its route may be referred to as “ports of call”.

Moreover, it should be noted that in the context of the present invention, the term “forecasting window” may refer to the days of future fuel price or index to predict, relative to the time when forecasting is made. The term “short-term” may refer to a forecasting window shorter than or equal to 5 working days; the term “long-term” may refer to a forecasting window longer than 5 working days.

The invention will now be described in greater detail, by way of examples, with reference to the figures. For ease of reference, common reference numerals or series of numerals will be used throughout the figures when referring to the same or similar features common to the figures.

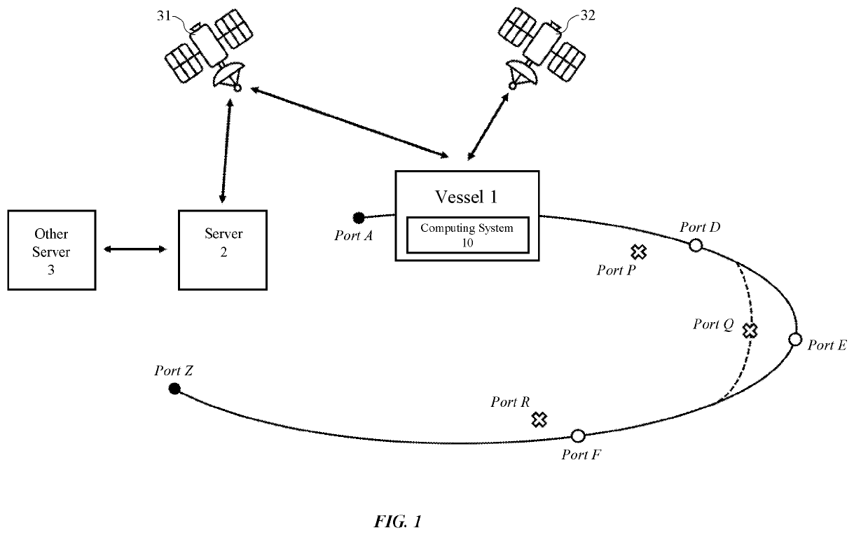

FIG. 1 is a diagram illustrating the overall infrastructure in which the present invention is to be implemented thereon. In particular, FIG. 1 illustrates a vessel 1 travelling along a pre-planned route (drawn in bold lines) after it sets off from an origin port A so that it reaches a destination port Z. Vessel 1, having a computing system 10, shall assist a decision-maker of the vessel 1 (for example, the vessel's captain), throughout the vessel's 1 journey along the pre-planned route.

Referring to FIG. 1, along the pre-planned route between the origin port A and the destination port Z, there are a number of ports located therebetween. Some of these ports are regarded as ports of call along the pre-planned route, such as port D, port E, and port F. Furthermore, there may be other ports that offer refuelling services that are in the vicinity of the aforementioned ports of call D, E, F, being port P, port Q, and port R.

Referring to FIG. 1, based on an example itinerary of the pre-planned route, vessel 1 is to stop by all ports D, E, F. However, it should be noted that not all of the ports D, E, F may offer refuelling operations. For example, port D may be a port of call where the vessel has to stop by to unload cargo and perform refuelling, port E may be a port of call where vessel 1 has to stop by to perform refuelling, and port F may be a port of call where the vessel 1 has to stop by to unload cargo but cannot undergo refuelling as refuelling services are not offered at this port.

Under these aforementioned considerations, prior to the journey of vessel 1, the decision-maker may enter a refuel term contract with a fuel supplier at port D. In a maritime setting, a refuel term contract may also be referred to as a bunker contract. A refuel term contract is a kind of contract in which a decision-maker agrees to a contractual obligation with a fuel supplier to buy fuel from the fuel supplier or sell fuel to the fuel supplier at an agreed-upon price. Furthermore, a refuel term contract may have a price basis that may be a date of nomination (DON) or a date of delivery (DOD). For a refuel term contract based on date of nomination (DON), the unit price is determined by the fuel price on the date when bunker fuel is nominated (ie. when an order is placed). For example, a decision maker is allowed to place an order 5 days before an actual delivery time; hence, the decision maker needs to forecast the fuel prices or indexes in the next 5 days. For a refuel term contract based on a date of delivery (DOD), the unit price is equal to the fuel price on the date when bunker fuel is delivered to a ship.

Referring to FIG. 1, as vessel 1 travels along the pre-planned route, its computing system 10 shall obtain status information of the vessel 1 and information from the outside world. For example, through known methods, it shall establish a multi-way communication link with a server 2 through a satellite 31. The server 2 is preferably at a stationary location. Since vessel 1 is sailing on the open sea, server 2 may be on land, or it may be on an anchored buoy.

In a first use case, the server 2 may act as a data aggregator for vessel 1 by aggregating information from the outside world. Server 2 may communicate with other servers 3 through wired or wireless means to aggregate data such as fuel prices, fuel indexes, port information, or the like. The server 2 may then pass the aggregated data back to the vessel 1 through the satellite 31. The computing system 10 of the vessel 1 shall then process the status information of the vessel 1 and the aggregated data from the outside world to forecast fuel prices and/or fuel indexes and to optimise refuelling costs as the vessel 1 travels along the pre-planned route.

In a second use case, the server 2 may act as a communication intermediary with other servers 3 so that a decision-maker of the vessel 1 can communicate with fuel suppliers for executing buy orders or sell orders of fuel based on the refuel term contract.

In a third use case, the server 3 may act as a cloud database to store information relating to the vessel 1. This may include the vessel's itinerary, current location, parameters, crew data, or the like.

Furthermore, the vessel 1 may include a communication link with a weather satellite 32 to receive information on weather conditions of the sea along its route of travel.

Depending on the status information of the vessel 1 and the aggregated data from the outside world, the computing system 10 may determine an optimal route. This optimal route may be the same as the pre-planned route, or it may be an alternative route that at least takes into account the itinerary of the vessel 1, agreed-upon refuel term contracts, or forecasted fuel prices and/or fuel indexes at refuelling ports.

Based on the example itinerary, the vessel 1 stops by ports D and F for unloading cargo and refuels at port D to honour the refuel term contract. This means that there is a degree of freedom in regard to stopping by port E for refuelling. With this, the computing system 10 may determine an example Optimal Route (portions thereof drawn in dotted lines) as seen in

FIG. 1. In the example Optimal Route, the route to be undertaken by vessel 1 has changed from port D→port E→port F to port D→port Q→port F.

For determining the example Optimal Route, the computing system 10 has to consider a number of factors. A first factor may be the estimated time of arrival (TOA) at both ports from the current location of the vessel 1. A second factor may be whether or not the forecasted price of fuel at port E (within the vessel's estimated TOA) will be more expensive compared to the forecasted price of fuel at port Q (within the vessel's estimated TOA). In this example Optimal Route, the computing system 10 may have determined that the estimated TOA of the vessel at both ports is more or less the same, and the forecasted price of fuel at port E is more expensive compared to the forecasted price of fuel at port Q. Hence, port E is discarded from the itinerary and changed to port Q in the example Optimal Route. As such, the computing system 10 would determine a route that optimises the fuel cost of vessel 1.

To further optimise fuel cost of vessel 1, the computing system 10 is to check fuel term contracts relating to the refuelling of vessel 1 that had been agreed-upon, for example, on a daily basis. Preferably, on each day, the computing system 10 determines whether or not it is worth it to fulfil a fuel term contract. This is done by comparing forecasted fuel prices and/or fuel indexes with current-day fuel prices and/or fuel indexes. Upon checking of a fuel term contract, should the computing system 10 determine that fulfilling a fuel term contract on a current date provides a profit to the decision-maker or the owner of vessel 1, the computing system 10 will nominate the fuel term contract to be fulfilled. The decision-maker may be informed of this through a human-machine interface (HMI) 18 of the vessel 1. Based on the example itinerary, this is preferably done on a daily basis prior to vessel 1 reaching port D.

It should be noted that the computing system 10 of the vessel 1 is a system of systems, wherein it further comprises a combination of one or more mechanical, electrical, or electronic systems. Each of these systems is substantially interfaced with each other so that communication between them takes place. Moreover, each of these systems has their own hardware and software components therewithin. Preferably, the computing system 10 at least further comprises a data-driven bunker planning system 11.

In addition to this, the computing system 10 may further comprise a fuel management system, a propulsion system, a ballast system, a cargo hold management system, a navigation system, a power supply system, a communication system, a data storage system, a positioning system, and the human-machine interface (HMI) system 18. These aforementioned systems may be implemented through well-known means on the vessel 1, and as such, further elaborations on these aforementioned systems are to be minimal.

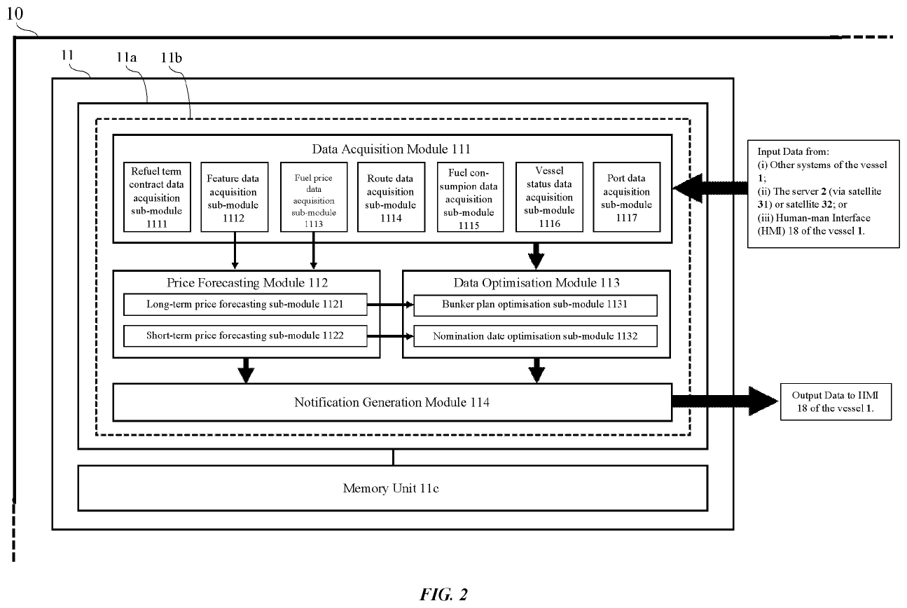

FIG. 2 shows a detailed block diagram of the data-driven bunker planning system 11 within the computing system 10 in its preferred embodiment. As shown, the data-driven bunker planning system 11 is a system within the computing system 10. The computing system 10 may be a conventional computer. The data-driven bunker planner system 11 may include a processor 11a, which runs an application software 11b, and at least one a memory unit 11c. The data-driven bunker planning system 11 is the system within the computing system 10 that forecasts fuel prices and/or fuel indexes and optimises refuel costs as the vessel 1 travels along its route. For it to do so, it is substantially interfaced with all of the other systems of the vessel 1.

It should be noted that the data-driven bunker planning system 11 may be implemented through other means. Since the data-driven bunker planning system 11 minimally just requires a processor 11a and a memory unit 11c, the data-driven bunker planning system 11 may be implemented together with or within other system as well through sharing of the hardware components in which the application software 11b may run thereon. For example, the data-driven bunker planning system 11 shares the same hardware components as the human-machine interface (HMI) system 18.

Within the data-driven bunker planning system 11, the processor 11a performs the scheduling and the execution of software instructions or computer logic instructions as instructed by an application software 11b running thereon. Preferably, the data-driven bunker planning system 11 is a conventional processor, application-specific integrated circuit (ASIC), a field-programmable gate array (FPGA), or a combination thereof. In regard to the memory unit 11c, it is preferably interfaced with the processor 11a. The memory unit 11c may store program files related to the application software 11b, or temporarily store processing data during runtime of the application software 11b.

It is further shown in FIG. 2 that the processor 11a operates one or more modules; these modules are software modules of the application software 11b that operates, or runs, on the processor 11a for computing algorithms and generating control instructions related to the optimisation of bunkering costs. These modules include a data acquisition module 111, a fuel price forecasting module 112, a data optimisation module 113, and a notification generation module 114. It should be noted that the presented modules need not be in a software embodiment, and may be a hardware embodiment where they are connected to the processor 11a or they may be their own independent computer system. Ancillary modules may be included to provide support for the aforementioned modules.

In one embodiment, the data acquisition module 111 serves to acquire status information of the vessel 1 and the aggregated data from the outside world. Preferably, it further comprises a refuel term contract data acquisition sub-module 1111, a feature data acquisition sub-module 1112, a fuel price data acquisition sub-module 1113, a route data acquisition sub-module 1114, a fuel consumption data acquisition sub-module 1115, a vessel status data acquisition sub-module 1116, and a port data acquisition sub-module 1117.

Regarding the refuel term contract data acquisition sub-module 1111, it preferably acquires one or more refuel term contracts that were agreed upon between the decision-maker and the fuel suppliers prior to the journey or during the journey. Preferably, the refuel term contract data is keyed in by the decision-maker through the HMI system 18 of vessel 1. Alternatively, the refuel term contract data is stored in server 2 or the vessel's data storage system, and is to be retrieved therefrom. The refuel term contract data includes:
(i) Refuelling or bunkering ports in which refuel term contracts have been made;
(ii) corresponding fuel suppliers in these refuelling ports in which refuel term contracts have been made therewith;
(iii) an agreed-upon minimum volume of fuel to be procured;
(iv) an agreed-upon maximum volume of fuel to be procured;
(v) service cost imposed by the supplier that is fixed;
(vi) an agreed-upon fuel index that shall be abided;
(vii) a premium cost of the refuel term contract;
(viii) an agreed-upon price basis of the refuel term contract, which may be a date of nomination (DON) or a date of delivery (DOD);
(ix) an estimated number of days in which the refuel contract is enforced before the vessel's estimated arrival at a port, and
(x) an estimated number of cut-off days in which the refuel contract is terminated before the vessel's estimated arrival at a port.

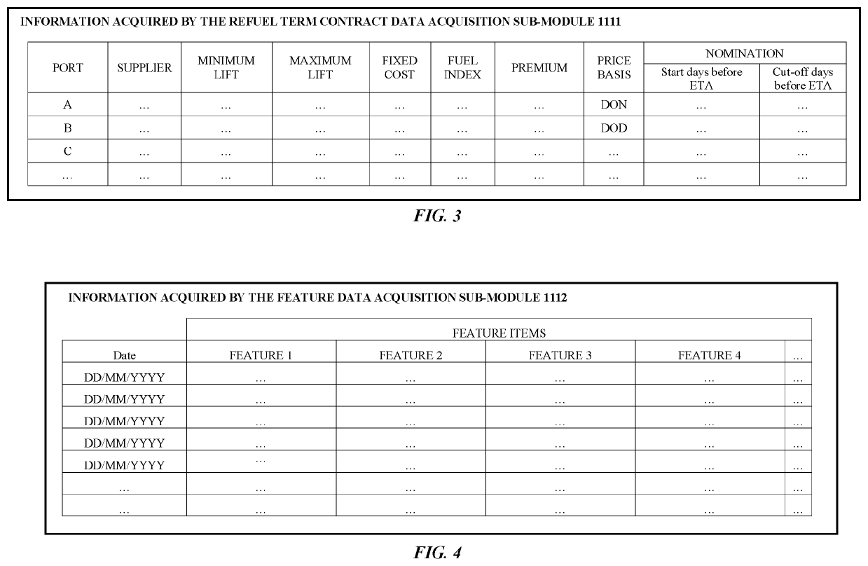

These data may be organized by the refuel contract data acquisition sub-module 1111 into a form that is shown in FIG. 3.

Regarding the feature data acquisition sub-module 1112, it preferably acquires and/or derives one or more feature item data from one or more datasets, these datasets being believed to have a substantial influence on future fuel prices and/or fuel indexes. These datasets are preferably aggregated by the server 2 from the outside world. In one embodiment, the feature data acquisition sub-module 1112 uses known statistical techniques to derive feature item data from the datasets. In one embodiment, the feature data includes:
(i) Date in which the feature item data is or was calculated;
(ii) A first feature item data, which may be a numerical weight corresponding to the influence of the West Texas Intermediate (WTI) crude oil prices on fuel prices;
(iii) A second feature item data, which may be a numerical weight corresponding to the influence of the New York Stock Exchange (NYSE) composite on fuel prices;
(iv) A third feature item data, which may be a numerical weight corresponding to the influence of the West Texas Intermediate (WTI) crude oil prices of the previous three days on the fuel prices;
(v) A fourth feature item data, which may be a numerical weight corresponding to the influence of the New York Stock Exchange (NYSE) composite of the previous three days on the fuel prices;

These data may be organized by the feature data acquisition sub-module 1112 into a form that is shown in FIG. 4.

It should be noted that certain feature item data may be regarded as “long forecast window” data and certain feature item data may be regarded as “short forecast window” data. For example, the aforementioned first feature item data and the second feature item data are regarded as “long forecast window” data as there is no specified range in the dataset in which they are derived therefrom. Whereas, the aforementioned third feature item data and the fourth feature item data may be regarded as “short forecast window” data as the dataset in which they are derived therefrom has a specified range over a short period of time (in this example, the previous three days).

Moreover, the number of feature item data is not limited to what was aforementioned. It may be any number thereof that provides an indicator of the influence of a dataset on future fuel prices and/or fuel indexes. This may include the influence of fuel refinery capacity of a depot on future fuel prices and/or fuel indexes, the influence of fuel refinery output of a depot on future fuel prices and/or fuel indexes, or the like.

Regarding the fuel price data acquisition sub-module 1113, it preferably acquires one or more fuel prices and/or fuel indexes. These fuel prices and/or fuel indexes are preferably aggregated by the server 2 from the outside world. If required, historical data of fuel prices and/or fuel index may also be acquired. For example, the fuel price data includes:
(i) Date of a fuel price or a fuel index;
(ii) A first fuel index, which may be a numerical value of the Bunker World Index (BWI);
(iii) A second fuel index, which may be a numerical value of the Bunker World 380 Index (BW380);
(iv) A third fuel index, which may be a numerical value of the Average Bunker Fuel Prices in the Asia-Pacific (APAC).

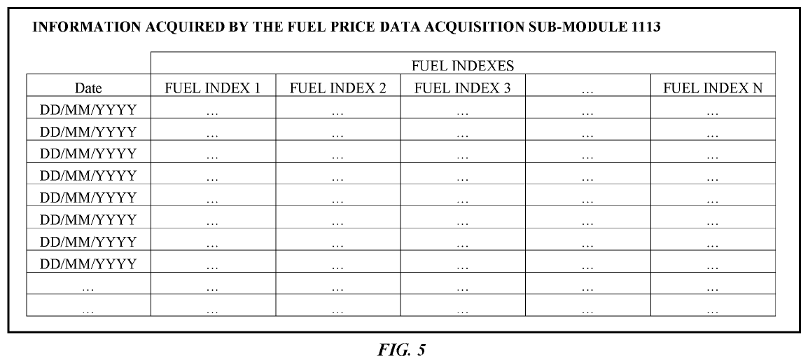

These data may be organized by the fuel price data acquisition sub-module 1113 into a form shown in FIG. 5. Furthermore, the number of fuel prices and/or fuel indexes may not be limited to what was aforementioned, and may be any number thereof.

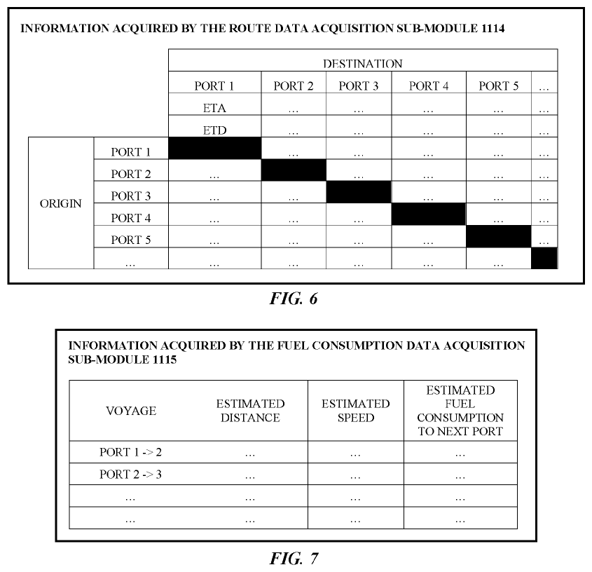

Regarding the route data acquisition sub-module 1114, it preferably acquires the route information of the vessel 1 based on the vessel's itinerary. For example, the route information includes the origin port, the destination port, port of calls in which cargo is to be loaded or unloaded, and port of calls in which refuelling is permissible. In addition to this, arrival dates and departure dates of the vessel 1 are included as well. These data may be keyed-in by the decision-maker into the HMI 18 interface of the vessel 1, or obtained from the server 2 or the vessel's data storage system. These data may be organized by the route data acquisition sub-module 1114 into a form shown in FIG. 6.

Regarding the fuel consumption data acquisition sub-module 1115, it preferably acquires the fuel consumption data of the vessel 1 based on information obtained from other systems within the computing system 10. For example, the fuel consumption data includes:
(i) port-to-port details;
(ii) The estimated distance between one port and another port.
(iii) Estimated speeds of the vessel as it journeys between one port and another port.
(iv) Estimated fuel consumption of the vessel as it journeys between one port and another port.

These data may be organized by the fuel consumption data acquisition sub-module 1115 into a form shown in FIG. 7.

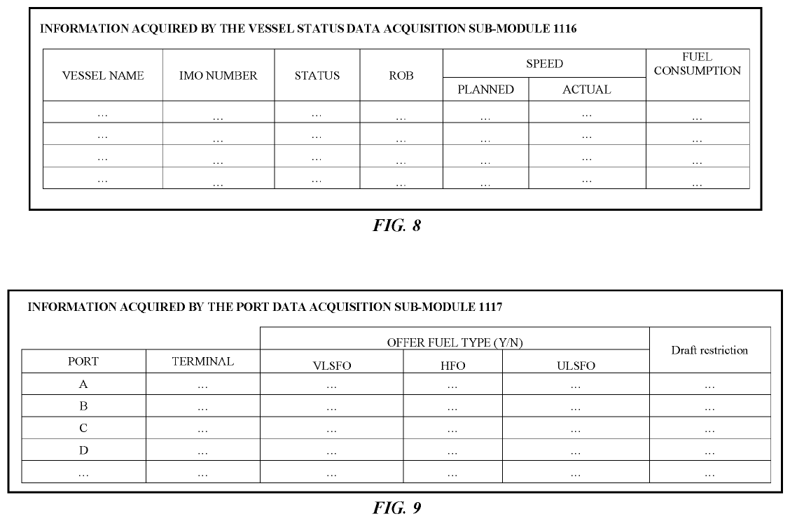

Regarding the vessel status data acquisition sub-module 1116, it preferably acquires the current status of the vessel at any given time during the vessel's voyage based on information obtained from other systems within the computing system 10. For example, the vessel status data includes:
(i) The name of the vessel;
(ii) The International Maritime Organization (IMO) number of the vessel.
(iii) The intended service of the vessel;
(iv) Timestamp of the status update;
(v) Planned speed of the vessel;
(vi) The actual speed of the vessel;
(vii) Predicted weather conditions along a current route, which may further include wind speeds, sea temperature, or the like;
(viii) Amount of cargo present in the vessel's cargo hold.
(ix) Amount of fuel remaining on board (ROB);
(x) Amount of fuel consumed;
(xi) Estimated distances from a current location to another port.
   These data may be organized by the fuel consumption data acquisition sub-module 1116 into a form shown in FIG. 8.

Regarding the port data acquisition sub-module 1117, it preferably acquires data on the ports that offer refuelling services that are located along the pre-planned route or nearby the pre-planned route. These data are preferably aggregated by the server 2 from the outside world. For example, the port data includes:
(i) Terminal name of the port;
(ii) Coordinate location of the port;
(iii) Fuel types offered by the ports, which may include Very Low Sulphur Fuel Oil (VLSFO), Heavy Fuel Oil (HFO), and Ultra Low Sulphur Fuel Oil (ULSFO);
(iv) Draft restrictions of the port.
   These data may be organized by the port data acquisition sub-module 1117 into a form as shown in FIG. 9.

In one embodiment, the bunker price forecasting module 112 serves to forecast the prices of fuel based on the data provided by both the feature data acquisition sub-module 1112 and the fuel price acquisition sub-module 1113. Preferably, it further comprises a long-term price forecasting sub-module 1121 and a short-term price forecasting sub-module 1122. In one embodiment, these fuel price forecasting sub-modules 1121, 1122 employ various customized machine learning and optimization models for long-term forecasting and short-term forecasting, including Ensemble Lasso, Random Forest, XGBoost, Support Vector Machine, trained Structural Prescriptive—Empirical Risk Management (SP-ERM) and/or trained Truncated Scenario—wise Linear Decision Rule—Empirical Risk Management (TSLDR-ERM). Depending on the forecasting window (or period in days of a future fuel price or index to predict relative to the time when forecasting is made, the best performing models are selected and integrated into the forecasting sub-modules 1121,1122. Preferably, this method of forecasting includes (i) a long-term decision-making and (ii) a short-term decision making. Long-term decision making is based on long-term forecasted fuel prices and/or fuel indexes, for example, with a forecasting window longer than 5 days—determining the optimal combinations of contracts when given a portfolio of contracts; short-term decision making is based on short-term forecasts, for example, with a forecasting window shorter than or equal to 5 days—determining the optimal time to place an order given the terms and contracts specified in the refuel term contract data in sub-module 1111.

Regarding the long-term forecasting sub-module 1121, it preferably uses feature data that is regarded as data over a long forecasting window period, such as the aforementioned first feature item data and the second feature item data, to generate numerical values representing fuel prices and/or fuel indexes over the long forecasting window. In another embodiment, long-term forecasting may refer to a forecasting window that is longer than 5 days. In addition, the planning horizon for long-term decision making may be substantially one month, meaning the decision maker needs to make refuelling decisions (when, where and how much to buy) for the following month.

Regarding the short-term forecasting sub-module 1122, it preferably uses feature data that is regarded as data over a short forecasting window, such as the aforementioned third feature item data and the fourth feature item data, to generate numerical values representing fuel prices and/or fuel indexes in the short forecasting window. In another embodiment, short-term forecasting may refer to a forecasting window that is shorter than or equal to 5 days, meaning the decision needs to forecast the fuel prices in the next 5 days and is allowed to place an order for refuelling 5 days before the actual delivery date. Short-term forecasting requires higher accuracy, but is relatively easy to decide; long-term forecasting is more challenging and may employ various customized machine learning and optimization models to forecast over a longer window period.

In one embodiment, the data optimisation module 113 serves to optimise bunkering costs as the vessel 1 travels along its journey. Preferably, it further comprises a bunker plan optimisation sub-module 1131 and a nomination date optimisation sub-module 1132.

More specifically, the bunkering plan optimisation sub-module 1131 is to determine a time, a quantity and a location for bunkering in which bunkering costs may be minimised. Whereas, the nomination date optimisation sub-module 1132 is to nominate an optimal time to place an order when given the refuel term contracts. With both sets of the information, a decision-maker is enabled to operate the vessel 1 along the planned route with minimised bunkering costs.

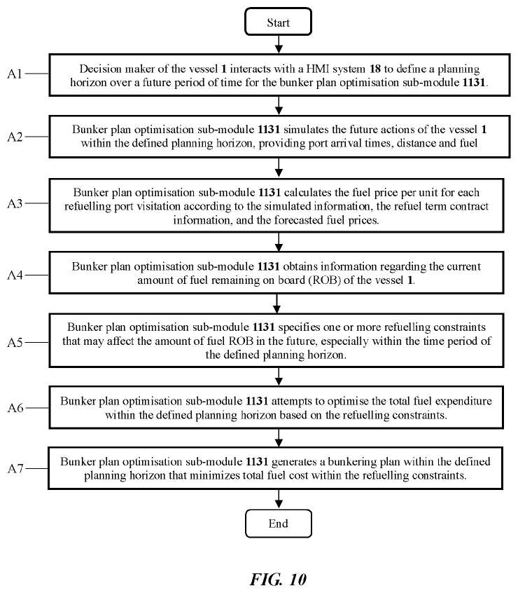

FIG. 10 shows an A-Series operational flow performed by the bunker plan optimisation sub-module 1131. The bunker plan optimisation sub-module 1131 is to perform a series of steps to determine the time, quantity and location for bunkering in which bunkering costs may be minimised using information from the data acquisition module 111, and the forecasted long-term fuel prices and/or fuel indexes from the long-term forecasting sub-module 1121 of the fuel price forecasting module 112.

First, in step A1, the decision-maker of the vessel 1 interacts with the HMI system 18 of vessel 1 to define a planning horizon over a future period of time for the bunker plan optimisation sub-module 1131. The planning horizon may be a customizable timeframe. For example, a timeframe of 90 days from a current location and time, a timeframe of 180 days after the vessel 1 departs from a port, a timeframe of the vessel at least stopping by at least two future ports in the itinerary, or the like.

Next, in step A2, the bunker plan optimisation sub-module 1131 simulates the future actions of the vessel in the defined planning horizon. For example, it simulates port arrival times of the vessel 1 based on the route data obtained from the route data acquisition sub-module 1114, and the current status of the vessel 1 obtained from the vessel status data acquisition sub-module 1116.

Next, in step A3, the bunker plan optimisation sub-module 1131 calculates the fuel price per unit for each port visitation. This is done in accordance with the simulation information from step A2, the refuel term contract information, and the forecasted long-term fuel prices and/or fuel indexes.

Next, in step A4, the bunker plan optimisation sub-module 1131 obtains information regarding the current amount of fuel remaining on board (ROB) of the vessel 1 from the vessel status data acquisition sub-module 1116.

Next, in step A5, the bunker plan optimisation sub-module 1131 specifies one or more refuelling constraints that may affect the amount of fuel ROB in the future, for example, within the time period of the defined planning horizon. For example, these refuelling constraints may include:
(i) The capacity of the fuel tanks;
(ii) The rate of usage of different types of fuels between the fuel tanks;
(iii) The future weather conditions of the route;
(iv) The minimum and maximum amount of fuel to be procured as specified in the refuel term contracts;
(v) Speed of the vessel 1;
(vi) Cargo remaining in the hold area of the vessel 1;
(vii) Electricity usage of the vessel 1.

Next, in step A6, the bunker plan optimisation sub-module 1131 attempts to minimise bunkering costs within the defined planning horizon based on these refuelling constraints.

Next, in the final step A7, the bunker plan optimisation sub-module 1131 generates a bunkering plan within the defined planning horizon and refuelling constraints.

Referring to FIG. 1 as well as its descriptions above, the example Optimal Route may be generated through the aforementioned series of steps performed by the bunker plan optimisation sub-module 1131.

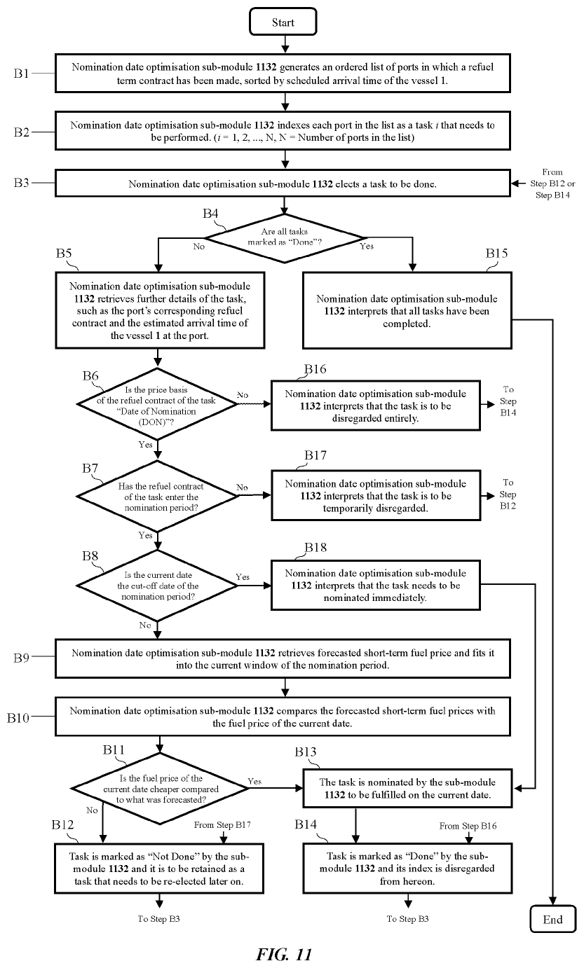

FIG. 11 illustrates a B-Series operational flow performed by the nomination date optimisation sub-module 1132. The nomination date optimisation sub-module 1132 is to perform a series of steps that allows the decision-maker to fulfil their contractual obligations at an optimal time based on data from the refuel term contract acquisition sub-module 1111, and the forecasted short-term fuel prices and/or fuel indexes from the short-term price forecasting sub-module 1122 of the fuel price forecasting module 112.

In step B1, the nomination date optimisation sub-module 1132 generates an ordered list of ports in which refuel term contracts have been made, sorted by the scheduled arrival time of the vessel 1.

Next, in step B2, the nomination date optimisation sub-module 1132 indexes each port in the list as a task i that needs to be performed. i is defined to be an ordered sequence of 1, 2, . . . , N, with N being the number of ports in the list.

Next, in step B3, the nomination date optimisation sub-module 1132 elects a task to be done.

The following from step B3 is step B4. Step B4 is a decision step in which it shall be determined whether or not all tasks have been marked as “Done”. Should this not be the case, step B4 proceeds to step B5. Should this be the case, step B4 proceeds to step B15.

In step B5, the nomination date optimisation sub-module 1132 retrieves further details of the task, such as the port's corresponding refuel term contract and the estimated arrival time of the vessel 1 at the port.

The following from step B5 is step B6. Step B6 is another decision step in which it shall be determined whether or not the refuel term contract of the task has an agreed-upon price basis that is “date of nomination (DON)”. Should this be the case, step B6 proceeds to step B7. Should this not be the case, step B6 proceeds to step B16.

Step B7 is another decision step in which it shall be determined whether or not a refuel term contract, which is on the price basis of “date of nomination”, has entered the nomination period based on the current date. Should this be the case, step B7 proceeds to step B8. Should this not be the case, step B7 proceeds to step B17.

Step B8 is another decision step in which it shall be determined whether or not the refuel term contract, which is on the price basis of “date of nomination”, has reached the cut-off date of the nomination period based on the current date. Should this be not the case, step B8 proceeds to step B9. Should this be the case, step B8 proceeds to step B18.

In step B9, the nomination date optimisation sub-module 1132 retrieves the forecasted short-term fuel price and/or fuel indexes and fits it into a current window of the nomination period. This current window is defined to be the duration of time between the current date and the cut-off date of the nomination period.

Next, in step B10, the nomination date optimisation sub-module 1132 compares the forecasted short-term fuel prices and/or fuel indexes with the fuel price and/or fuel index of the current date.

The following step from step B10 is step B11. Step B11 is another decision step in which it shall be determined whether or not the fuel price and/or fuel index of the current date is cheaper than the forecasted short-term fuel price and/or fuel index. Should this not be the case, step B11 proceeds to step B12. Should this be the case, step B11 proceeds to step B13.

In step B12, since it was determined that the fuel price and/or fuel index of the current date is more expensive than the forecasted short-term fuel price and/or fuel index, the task is to be marked as “Not Done”, and it is to be retained as a task that needs to be re-elected later on.

In step B13, since it was determined that the fuel price and/or fuel index of the current date is cheaper than the forecasted short-term fuel price and/or fuel index forecasted by the price forecasting module 112, it is regarded that the current date is the optimal time for the refuel term contract to be fulfilled. As such, the task is nominated by the nomination date optimisation sub-module 1132 so that the refuel term contract is fulfilled on the current date.

The following step from step B13 is step B14. In B14, the task is to be marked as “Done”, and its corresponding index is to be disregarded by the nomination date optimisation sub-module 1132 from hereon.

For now, steps B16, B17 and B18 are described.

In step B16, since it was determined the refuel term contract of the task does not have an agreed-upon price basis that is “date of nomination (DON)”, the nomination date optimisation sub-module 1132 interprets that the task is to be disregarded entirely.

As such, the following step from step B16 is step B14, whereby the task is to be marked as “Done”, and its corresponding index is to be disregarded by the nomination date optimisation sub-module 1132 from hereon.

In step B17, since it was determined that the refuel term contract, which is on the price basis of “date of nomination”, has yet to enter the nomination period based on the current date, the nomination date optimisation sub-module 1132 interprets that the task is to be temporarily disregarded.

As such, following from step B16 is step B12, whereby the task is to be marked as “Not Done”, and it is to be retained as a task that needs to be re-elected later on.

In step B18, since it was determined that the refuel term contract, which is on the price basis of “date of nomination”, has reached the cut-off date of the nomination period based on the current date, the nomination date optimisation sub-module 1132 interprets that the task needs to be nominated immediately.

As such, following from step B18 is step B13, whereby the task is nominated by the nomination date optimisation sub-module 1132 so that the term contract is fulfilled on the current date. Once again, following from step B13 is step B14. In B14, the task is to be marked as “Done”, and its corresponding index is to be disregarded by the nomination date optimisation sub-module 1132 from hereon.

Following from step B12 or B14 is step B3. This means that upon marking a task as “Not Done” or “Done”, the nomination date optimisation sub-module 1132 once again elects a task as a following task to be done. It is preferable that the nomination date optimisation sub-module 1132 elects a following task in a sequential manner based on the task index. This may be done by incrementing the task index i by a value of 1 so that the following task should have an index of i+1. With this, step B3 once again proceeds to step B4 and the whole process flow begins for this following task.

Step B15, which may be regarded as the final step in the B-Series operational flow, will now be described. In step B15, since it was determined that all tasks have been marked as “Done”, the nomination date optimisation sub-module 1132 interprets that all tasks have been completed. With this, the B-Series operational flow comes to an end. The nomination date optimisation sub-module 1132 may then inform the decision-maker through the HMI system 18 of the vessel 1 that all tasks have been completed.

The notification generation module 114 serves to generate one or more notifications that are to be presented to the decision-maker through the HMI system 18 of the vessel 1. For example, the notification generation module 114 shall output at least three different notifications, which include (i) the forecasted fuel prices and/or fuel indexes, (ii) the refuel term contract nominations, and (iii) the bunkering plan for the remainder of the journey.

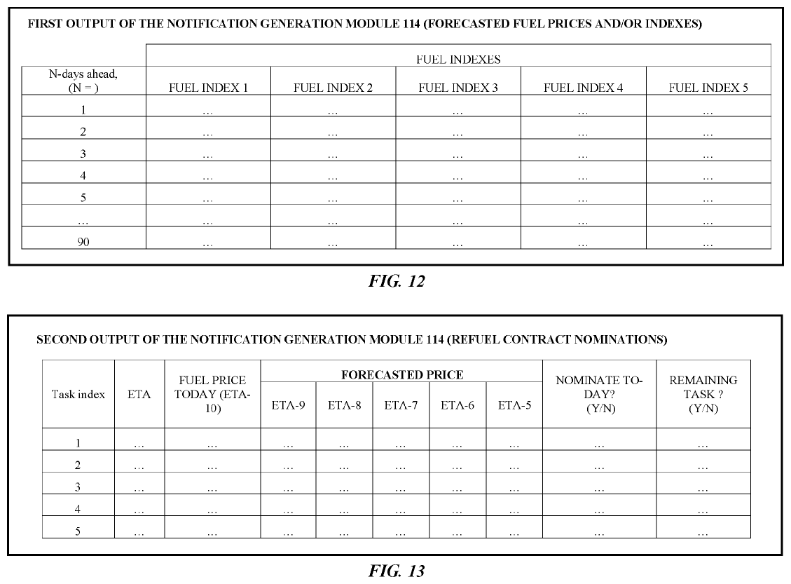

The forecasted fuel prices and/or indexes, being the first output of the notification generation module 114, may be organized by the vessel's HMI system 18 to be displayed to the decision-maker in a manner shown in FIG. 12. In one embodiment, the forecasted fuel prices include:
(i) Number of days ahead from a current date;
(ii) One or more forecasted fuel prices and/or fuel indexes.

For example, regarding the number of days ahead from the current date, the number of days may vary depending on the configuration of the application software 11b. As for the fuel prices and/or fuel indexes, they may be from either one or both the long-term forecasting sub-module 1121 or the short-term forecasting sub-module 1122 of the price forecasting module 112. Preferably, the forecasted fuel prices and/or indexes by trimming and combining the long-term and short-term forecasted fuel prices and/or indexes obtained from the long-term forecasting sub-module 1121 and the short-term forecasting sub-module 1122. For example, the fuel price and/or fuel index adopted may be a mid-point value between the long-term and short-term forecasted fuel prices and/or indexes.

For example, for the number of days ahead <40 days, the forecasted short-term fuel prices and/or indexes from the short-term forecasting sub-module 1122 will be used. Whereas for the number of days ahead >40 days, forecasted long-term fuel prices and/or indexes from long-term forecasting sub-module 1121 will be used.

The refuel term contract nominations, being the second output of the notification generation module 114, may be organized by the vessel's HMI system 18 to be displayed to the decision-maker in a manner shown in FIG. 13. For example, the refuel term contract nomination includes:
(i) Task index of the refuel contract;
(ii) Estimated time of arrival of the vehicle to a port where refuel term contract was agreed-upon;
(iii) Fuel price and/or fuel index of the current date;
(iv) Forecasted fuel prices and/or fuel indexes in descending time of arrival (TOA) of the vessel 1;
(v) An indicator that indicates that the refuel term contract should be nominated for fulfilment;
(vi) An indicator that indicates that the refuel term contract should remain as a task.

For example, the forecasted fuel prices and/or fuel indexes in descending TOA of the vessel 1 are from the short-term forecasting sub-module 1122 of the price forecasting module 112.

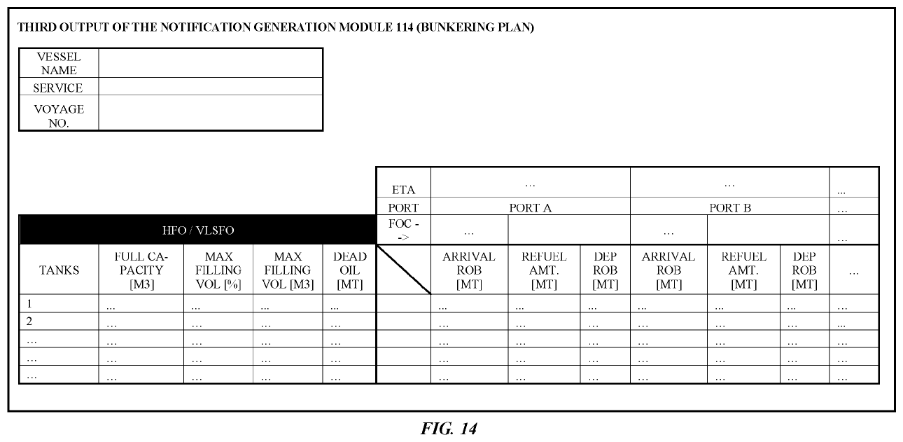

The bunkering plan, being the third output of the notification generation module 114, may be organized by the vessel's HMI system 18 to be displayed to the decision-maker in a manner shown in FIG. 14. For example, the bunkering plan is an ordered list of the status of each fuel tank in the vessel 1, preferably, at least includes:
(i) Name of the vessel;
(ii) Intended service of the vessel;
(iii) Journey serial number;
(iv) The fuel tanks available on the vessel, each of them being identified with an index number;
(v) Type of fuel that is acceptable by the fuel tanks;
(vi) Maximum capacity of the fuel tank;
(vii) The preferred maximum filling volume of the tank;
(viii) The preferred maximum filling volume of the tank in percentages;
(ix) The volume of dead oil within the tank;
(x) Ports of call in which the vessel 1 will stop by;
(xi) Estimate time of arrival (TOA) of the vessel 1 at each of the port;
(xii) Fuel consumed by the time the vessel 1 arrives at the port;
(xiii) Fuel remaining on board (ROB) when the vessel 1 arrives at the port;
(xiv) Fuel to be refilled into, or bunkered into, the tank;
(XV) Fuel remaining on board (ROB) when the vessel departs from the port.

With this, the details pertaining to the computing system 10 and the data-driven bunker planner system 11 of the present invention have been sufficiently elucidated. In addition to the advantages explained above, the present invention further provides an improved vessel operations management in the maritime setting. Moreover, the present invention further provides a decision-maker further flexibility in managing their fuel as a derivative, and as such, they can effectively employ risk management strategies such as fuel price hedging.

The present disclosure includes as contained in the appended claims, as well as that of the foregoing description. Although this invention has been described in its preferred form with a degree of particularity, it is understood that the present disclosure of the preferred form has been made only by way of example and that numerous changes in the details of construction and the combination and arrangements of parts may be resorted to without departing from the scope of the present invention.

1.-18. (canceled)

19. A data-driven bunker planner system comprising:
a bunker planning system operable in a computing system located in a vessel;
wherein the bunker planning system is operable to forecast fuel prices and/or fuel indexes and to determine an optimal time, quantity and location to refuel, to fulfil one or more refuel term contracts based on the forecasted fuel prices and/or fuel indexes.

20. The system according to claim 19, wherein the bunker planning system further comprises a data acquisition module.

21. The system according to claim 20, wherein the data acquisition module further comprises:
a refuel term contract data acquisition sub-module;
a feature data acquisition sub-module;
a fuel price data acquisition sub-module;
a route data acquisition sub-module;
a fuel consumption data acquisition sub-module;
a vessel status data acquisition sub-module; and
a port data acquisition sub-module.

22. The system according to claim 21, wherein the bunker planning system further comprises a fuel price forecasting module.

23. The system according to claim 22, wherein the fuel price forecasting module further comprises:
a long-term price forecasting sub-module; and
a short-term price forecasting sub-module.

24. The system according to claim 22, wherein the bunker planning system further comprises a data optimisation module.

25. The system according to claim 24, wherein the data optimisation module further comprises:
a bunker plan optimisation sub-module; and
a nomination date optimisation sub-module.

26. The system according to claim 24, wherein the bunker planning system further comprises a notification generation module.

27. The system according to claim 26, wherein the notification generation module generates any one of a combination of notifications that comprise:
forecasted fuel prices and/or fuel indexes;
refuel term contract nominations; or
a bunkering plan.

28. The system according to claim 27, wherein the fuel price forecasting module receives data from the feature data acquisition sub-module and the fuel price data acquisition sub-module.

29. The system according to claim 22, wherein the fuel price forecasting module employs at least one customized machine learning and optimization model for long-term forecasting and short-term forecasting selected from: Ensemble Lasso, Random Forest, XGBoost, Support Vector Machine, a trained Structural Prescriptive—Empirical Risk Management (SP-ERM) or a trained Truncated Scenario-wise Linear Decision Rule—Empirical Risk Management (TSLDR-ERM).

30. The system according to claim 24, wherein the data optimisation module receives data from the data acquisition module and the fuel price forecasting module.

31. The system according to claim 21, wherein the bunker planning system communicates with a server to obtain data for the data acquisition sub-modules.

32. The system according to claim 31, wherein the bunker planning system further comprises a human-machine interface system to allow a decision-maker to input information into the bunker planning system and for the bunker planning system to output the bunkering plan.

33. A method for optimising bunkering costs for a vessel, comprising:
forecasting fuel prices and/or fuel indexes using a bunker planning system located on the vessel.

34. The method according to claim 33, further comprising:
determining an optimal time to place an order in the short term, or determining an optimal combination of contracts in the long-term, with the given refuel term contracts.

35. The method according to claim 33, wherein the step of forecasting fuel prices and/or fuel indexes employs at least one customized machine learning and optimization model for long-term forecasting and short-term forecasting selected from: Ensemble Lasso, Random Forest, XGBoost, Support Vector Machine, trained Structural Prescriptive—Empirical Risk Management (SP-ERM) or trained Truncated Scenario-wise Linear Decision Rule—Empirical Risk Management (TSLDR-ERM).

36. The method according to claim 33, further comprising outputting a bunkering plan based on the forecasted fuel prices and/or fuel indexes and results of data optimisation relating to data on a planned route, fuel consumption, vessel status and a port of call.
